(19) United States
(12) Patent Application Publication
(10) Pub. No.: US 2005/0012069 A1
(43) Pub. Date: Jan. 20, 2005

(54) Heat-transfer fluid containing nano-particles and carboxylates

(76) Inventors: Jean-Pierre Maes, Merelbeke (BE); Serge Lievens, Merelbeke (BE); Peter Roose, Sint-Martens-Latem (BE); Cecile Libot, Courbevoie (FR)

Correspondence Address: CHEVRON TEXACO CORPORATION, P.O. BOX 6006, SAN RAMON, CA, 94583-0806, US

(21) Appl. No.: 10/311,124

(22) PCT Filed: Jun. 13, 2001
(86) PCT No.: PCT/EP01/06748

(30) Foreign Application Priority Data
Jun. 19, 2000 (EP) 00305173.7

(51) Int. Cl. C09K 5/00

(52) U.S. Cl. 252/73

(57) ABSTRACT

The use of sub-micron particles (nano-particles) and carboxylates for improving the heat-exchange characteristics of heat-transfer fluids or antifreeze coolants. The carboxylates form a stable physisorbed- or chemisorbed carboxylate protective layer on metallic nano-particles that does not hinder heat-transfer. The combination of carboxylates and metallic nano-particles provide excellent corrosion protection, improved heat-transfer and enhances the stability of the sub-micron particles (nano-particles) in suspension. Sub-micron particles (nano-particles) treated with carboxylates to form a chemisorbed carboxylate protective layer are used in a heat transfer fluid or a lubricant or hydraulic fluid or soap.

The present invention relates to the application of sub-micron particles (nano-particles) and carboxylates for improving the heat-transfer characteristics of heat-transfer fluids or antifreeze coolants. The carboxylates form a stable physisorbed- or chemisorbed carboxylate protective layer on metallic nano-particles that does not hinder heat-transfer. The combination of carboxylates and metallic nano-particles provide excellent corrosion protection, improved heat-transfer and stability.

### BACKGROUND OF THE INVENTION

Heat-transfer fluids are used as heat carriers in many applications. Examples of use of heat-transfer fluids include the removal or exchange of excess heat from stationary and automotive internal combustion engines, heat generated by electrical motors and generators, process heat and condensation heat (e.g. in refineries and steam generation plants). In all of these applications the thermal conductivity and heat capacity of the heat-transfer fluid are important parameters in the development of energy-efficient heat-transfer equipment. To improve the total efficiency of their equipment, industries have a strong need to develop heat-transfer fluids with significantly higher thermal conductivities than presently available. It is well known that solids and in particular, metals have an order of magnitude larger thermal conductivities than fluids. Therefor, the thermal conductivities of fluids that contain suspended solid, and in particular, metallic particles would be expected to be significantly enhanced when compared with conventional fluids. Many theoretical and experimental studies of the effective thermal conductivity of dispersions that contain solid particles have been conducted since Maxwell's theoretical work published in 1881. Maxwell's model shows that the thermal conductivity of suspensions that contain spherical particles increases with the volume fraction of the solid particles. It has also been shown that the thermal conductivity of suspensions increases with the ratio of the surface area to volume of the particle. Modern manufacturing techniques provide opportunities to process materials on a micro- and nanometer scale. The use of nano-particles was proposed (S. U. Choi, ASME Congress, San Francisco, Calif., Nov. 12-17, 1995) in heat-transfer fluids such as water, ethylene glycol and engine oil to produce a new class of engineered fluids (nanofluids) with improved heat-transfer capabilities. S. U. Choi et al. (ASME Transactions 280, Vol. 121, May 1999) report thermal conductivity measurements on fluids containing Al₂O₃ and CuO nano-particles. These experiments have shown that nanofluids, containing only a small amount of nano-particles, have substantial higher thermal conductivities then the same liquids (water, ethylene glycol) without nano-particles.

It is an object of the present invention to provide improved heat-transfer characteristics for heat-exchange fluids that contain carboxylates, by the addition of metallic sub-micron particles (nano-particles) to these heat-exchange fluids.

### PRIOR ART

German Patent DE 4,131,516 describes a heat-transfer fluid especially for solar collectors that contains finely divided aluminum powder and preferably phenolic antioxidant, anti-agglomerant and surfactant.

Co-assigned EP-A-0,229,440, EP-A-0,251,480, EP-A-0,308,037 and EP-A-0,564,721 describe the use of carboxylate salts as corrosion inhibitors in aqueous heat exchange fluids or corrosion-inhibited antifreeze formulations. Improved corrosion protection is found for these carboxylate corrosion inhibitor combinations, compared to prior art corrosion inhibitors. EPA No. 99930566.1 describes aqueous solutions of carboxylates that provide frost and corrosion protection. Aqueous solutions of low carbon (C1-C2) carboxylic acid salts, in combination with higher carbon (C3-C5) carboxylic acid salts, were found to provide eutectic, freezing protection. Improved corrosion protection was found by adding one or more than one C6-C16 carboxylic acids. The advantage of these carboxylic salts based cooling fluids over ethylene glycol- or propylene glycol cooling fluids is improved heat-transfer due to a higher specific heat and improved fluidity resulting from the higher water content at the same frost protection.

### FIELD OF THE INVENTION

It has been found that the carboxylates react with the metallic surface to form a stable physisorbed- or chemisorbed carboxylate protective layer. This molecular layer protects the nano-particle from corrosion and stabilizes the colloidal solution or suspension of the nano-particles in a fluid with carboxylate components. Unlike protective films formed by traditional corrosion inhibitors the carboxylate physisorbed- or chemisorbed layer on the particle surface, does not impede the heat-transfer at the particle surface fluid interface. With traditional corrosion inhibitors relatively thick protective layers are formed that protect the metal from corrosion. However, the heat-exchange efficiency at the metallic surface-fluid interface is reduced by the thermal insulating properties of the protective film. It has been found that metallic nano-particles can be treated with carboxylates to provide a stable chemisorbed film on the metallic surface of the nano-particles. This treatment has been found to provide the nano-particles with a chemically bonded, corrosion and solvent resistant protective surface film. The carboxylate-treated metallic sub-micron particles (nano-particles) can be used in other functional fluids or soaps, such as lubricants and greases, to improve the thermal conductive properties of these fluids or soaps. The chemisorbed carboxylate layer on the particles provides corrosion protection and ensures optimized heat-transfer characteristics at the particle surface.

One aspect of the invention relates to the addition of metallic or non-metallic nano-particles to heat-exchange fluids or engine coolants that contain C1-C16 carboxylates in order to further improve the heat-transfer characteristics of these fluids by increasing the thermal conductivity and heat capacity of the fluids. Another aspect of the invention relates to the addition of metallic nano-particles to such heat-exchange fluids or engine coolants. The carboxylates contained in these fluids have been found to interact with the metallic surface or oxide surface of the metallic nano-particles to form a stable physisorbed- or chemisorbed carboxylate protective layer. This molecular layer apparently protects the nano-particle from corrosion. Unlike traditional corrosion inhibitors, the carboxylate physisorbed or chemisorbed layer on the particle surface does not impede the heat transfer at the particle surface.

Maes et al. (ASTM STP 1192, p. 11-24, 1993) describe the corrosion protection afforded by carboxylate corrosion inhibitors compared to more traditional corrosion inhibitors. The efficiency of the carboxylate inhibitor was evaluated in weight loss corrosion tests under static and dynamic conditions. The thermal properties of the protective film formed by carboxylate corrosion inhibitor on the metallic surface was evaluated under dynamic conditions, in comparison with the thermal properties of protective films formed by conventional corrosion inhibitors. The temperatures of metallic coupons were monitored during dynamic heat-transfer tests as described in ASTM STP 1192, p. 11-24. A constant heat input (2000 W) was maintained. FIG. 1 shows the mid-section temperature of a heated aluminum test specimen as recorded for a good performing conventional inhibitor and for the carboxylate inhibitor in coolant solutions. The mid-section metal temperature for the solution containing the carboxylate inhibitor remains fairly constant at about 170° C., while for the conventional inhibitor much higher temperatures are found (190° C. is reached after 60 hours test duration). Since the thermal properties of the fluids are about equal, the temperature differential can be attributed to the protective film formed at the metal-fluid interface. It is thought that the formation of a relatively thick layer for the conventional inhibitor thermally insulates the metal and hinders effective heat-transfer. Under the dynamic conditions in the test, the insulating property of the protective film causes the temperature to rise. With the carboxylate inhibitor the temperature remains fairly constant, indicating that the protection afforded by the carboxylates does not interfere with the heat transfer at the metal-fluid interface.

Tentative protection mechanisms for carboxylate inhibitors have been described by Darden et al. (SAE paper 900804, 1990). The carboxylate anion forms a complex with the metal while it is still bound to its solid lattice. No bulk layer is formed, rather a layer of microscopic thickness at the anodic sites on the metal surface. A further characterization of layers formed by carboxylate inhibitors was reported in work by Verpoort et al. (Applied Spectroscopy, Vol. 53, No 12, 1999, p. 1528-1534). Carboxylate films formed under dynamic heat-transfer conditions were studied with the use of X-ray photoelectron spectroscopy (XPS) and Fourier transform infrared (FT-IR). On basis of this characterization study and various insights from the literature, the general corrosion protection mechanism for carboxylate corrosion inhibitors is shown in FIG. 2. The carboxylates form a stable physisorbed- or chemisorbed carboxylate protective layer on the metallic surface. The chemisorbed layer is formed when the specimen is subjected to intensive heat-transfer. XPS analysis of the surface of the coupon subjected to heat-transfer clearly proved the presence of chemically bonded carboxylates. Even after rinsing with solvents such as methanol and acetone, the carboxylate bond was still found to be present.

### FIGURES

FIG. 1 shows the effect of protective films formed by conventional and carboxylate corrosion inhibitors on coupon temperature in dynamic heat-transfer test conditions.

FIG. 2 shows the general mechanism for inhibition of metallic corrosion by carboxylic acids

FIG. 3 is a schematic diagram showing nano-particles containing conventional and carboxylate inhibitors

### DISCLOSURE OF THE INVENTION

Application of Nano-Particles in Fluids Containing Carboxylate Inhibitors.

One object of the present invention is to provide improved heat-transfer characteristics for heat-exchange fluids that contain carboxylates, by the addition of sub-micron particles (nano-particles) to those heat-exchange fluids.

Carboxylates Provide Improved Heat-Transfer Properties to Fluids Containing Nano-Particles.

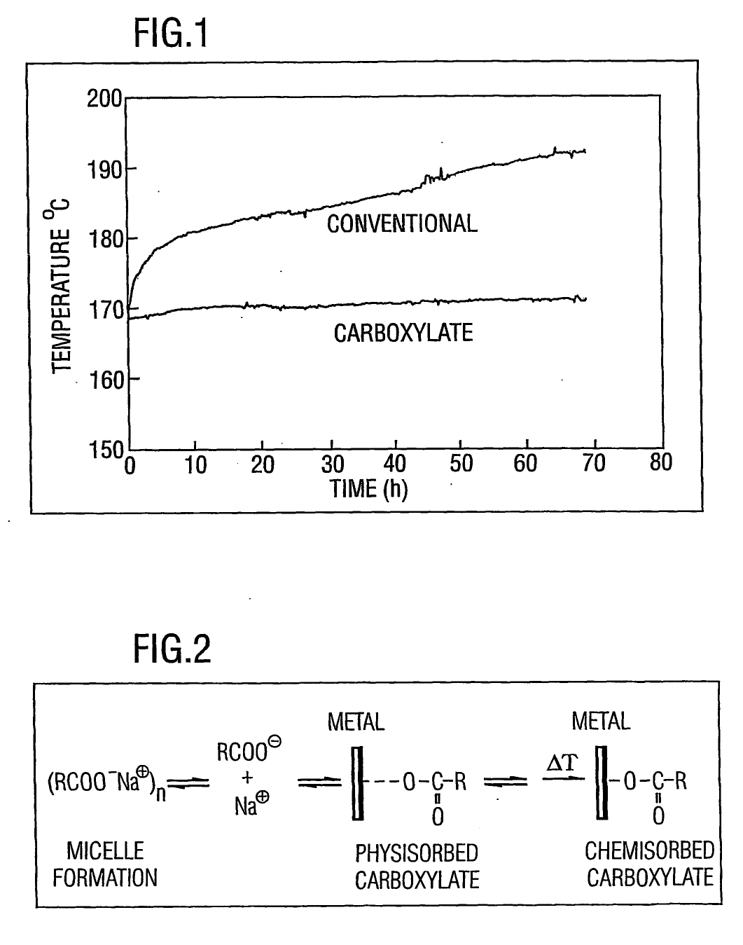

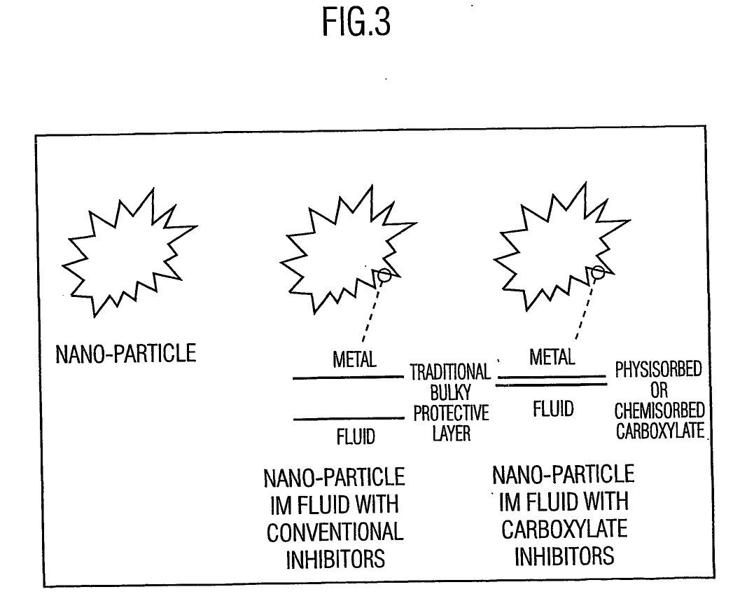

As demonstrated in FIG. 1 for aluminum, carboxylates react with a metallic surface to form a stable physisorbed- or chemisorbed carboxylate protective layer. This molecular layer has been found on nano-particles and protects the nano-particle from corrosion. Unlike protective films formed by traditional corrosion inhibitors the carboxylate physisorbed or chemisorbed layer (FIG. 2) on the particle surface does not impede the heat-transfer at the particle surface fluid interface. In contrast, traditional corrosion inhibitors will form relatively thick layers that protect the metal from corrosion. However, the heat-exchange efficiency at the metallic surface-fluid interface is reduced by the thermal insulating properties of the protective film. FIG. 3 provides a schematic outline of how metallic nano-particles are thought to be protected by the system of the invention.

Carboxylates Stabilize the Colloidal Solution or Suspension of the Nano-Particles.

Due to the micelle structure of the carboxylates in solution and the physisorbed- or chemisorbed carboxylates at the surface of the nano-particles (FIG. 2), the carboxylates have been found to stabilize the colloidal solution or suspension of the nano-particles in a fluid. This is an advantage over systems of the prior art.

Carboxylates Can Be Used to Treat Nano-Particles.

Another object of the invention is to treat metallic nano-particles with carboxylates to provide a stable chemisorbed film on the metallic surface of the nano-particles. This treatment provides the nano-particles with a chemically bonded, corrosion and solvent resistant protective surface film that does not impede heat-transfer.

Carboxylate-Treated Nano-Particles are Useful in Other Engineering Fluids or Soaps.

Another object of the invention is to use the said carboxylate-treated metallic sub-micron particles (nano-particles) in other functional fluids or soaps, such as lubricants and greases, to improve the thermal conductive properties of these fluids or soaps. The chemisorbed carboxylate layer on the particles provides corrosion protection and ensures optimized heat-transfer characteristics at the particle surface.

1. The use of sub-micron particles (nano-particles) and carboxylates for improving the heat-transfer characteristics of heat-transfer fluids or antifreeze coolants.

2. The use as claimed in claim 1 of a combination of one or more C₁-C₁₆ carboxylic acids or carboxylic acid salts and sub-micron particles (nano-particles).

3. The use as claimed in claim 1 of a combination of a salt of one or more C₁-C₅ carboxylic acids or the salts thereof, one or more C₆-C₁₆ carboxylic acids or the salts thereof, and sub-micron particles (nano-particles).

4. A method for improving the heat-transfer capacity of a fluid by adding to or dispersing within said fluid, sub-micron particles (nano-particles) treated with at least one C₁-C₁₆ carboxylic acid or carboxylic acid salt.

5. A method for improving the heat-transfer capacity of a soap by adding to or dispersing within said soap, sub-micron particles (nano-particles) treated with at least one C₁-C₁₆ carboxylic acid or carboxylic acid salt.

6. A method as claimed in claim 4 wherein said fluid is a heat-exchange fluid based on a water soluble alcohol freezing point depressant.

7. A method as claimed in claim 4 or claim 5 wherein said fluid or soap is a lubricant or hydraulic fluid based on mineral or synthetic oil, mineral or synthetic soap, or grease.

8. A heat exchange fluid or soap comprising a combination of one or more C₁-C₁₆ carboxylic acids or salts thereof and sub-micron particles (nano-particles).
